(19) United States
(12) Patent Application Publication
(10) Pub. No.: US 2021/0292615 A1
(43) Pub. Date: Sep. 23, 2021

(54) Low Density Epoxy Syntactic Structural Adhesive for Automotive Applications

(71) Applicant: Huntsman Advanced Materials Americas LLC, The Woodlands, TX (US)

(72) Inventors: Wenfeng Kuang, The Woodlands, TX (US); Rui Xie, The Woodlands, TX (US); Jose Trevino, III, The Woodlands, TX (US)

(21) Appl. No.: 16/968,915

(22) PCT Filed: Feb. 14, 2019
(86) PCT No.: PCT/US2019/017938

§ 371 Date: Aug. 11, 2020

Related U.S. Application Data
(60) Provisional application No. 62/630,944, filed on Feb. 15, 2018.

(51) Int. Cl. C09J 163/00

(52) U.S. Cl. CPC C09J 163/00; C08K 13/02

(57) ABSTRACT

The present disclosure provides a syntactic structural adhesive comprising an epoxy resin, a low density particulate filler and a hardener that, upon curing, exhibits at least the following well-balanced properties: (i) a density less than 1 g/cm³; (ii) a compression modulus greater than 500 MPa; and (iii) a lap shear strength greater than 750 psi. The syntactic structural adhesive may be used in a variety of applications, such as in automotive applications for bonding and/or sealing metal, plastic and composite parts.

### CROSS-REFERENCE TO RELATED APPLICATION

The present application claims priority to U.S. Provisional Patent Application Ser. No. 62/630,944, filed Feb. 15, 2018, the entire contents of which is hereby expressly incorporated herein by reference.

### STATEMENT REGARDING FEDERALLY SPONSORED RESEARCH OR DEVELOPMENT

Not applicable.

### FIELD OF THE INVENTION

The present disclosure generally relates to a syntactic structural adhesive comprising an epoxy resin, a low density particulate filler and a hardener. The syntactic structural adhesive is particularly useful in automotive applications for bonding and/or sealing metal, plastic and composite parts.

### BACKGROUND OF THE INVENTION

Fuel efficiency has become important in the design of the next generation of automobiles. In order to improve fuel economy, automotive manufacturers have begun to replace heavier-weight metals used in the production of cars and trucks with lighter-weight metals, plastic and composite parts. Because mechanical fasteners (nuts, bolts, screws, rivets, etc.) normally used in assembling heavier-weight metals are not always practical for assembling these lower-weight parts, the use of structural adhesives in assembly processes has become more and more prevalent. Structural adhesives can not only reduce vehicle weight (it has been estimated that these adhesives may provide up to a 20% by weight savings versus metal fasteners), but parts no longer need holes drilled or punched and assemblers do not have to measure torque or double-check fastening operations to ensure proper bonding.

The structural adhesives that have replaced or augmented metal fasteners and/or welds during automotive assembly are generally based on epoxy resins, polyurethanes and acrylic resins. For example:

WO 2016/108958 discloses a one-component structural adhesive comprising an epoxy resin, a polyurethane based toughener, at least one amphipathic block copolymer and one or more curing agents. This structural adhesive is taught to exhibit improved impact resistance at low temperatures;

U.S. Pat. No. 9,534,072 discloses a structural adhesive prepared from the reaction of an organic polyisocyanate with a compound containing isocyanate-reactive hydrogen atoms in the presence of a trimerization catalyst. This structural adhesive is taught to exhibit good adhesion in more severe climate conditions, such as at elevated temperature or in salty conditions;

WO 2015/164031 discloses a two-component structural adhesive comprising an acrylate polyurethane, an epoxy resin, a polythiol and a polyamine. This structural adhesive is taught to exhibit reduced read-through;

US 2014/0147677 discloses a structural adhesive comprising an epoxy resin and a hardener where the hardener is present in an amount of about equal to or less than the stoichiometric amount relative to the epoxy resin. This structural adhesive is taught to have good humidity resistance, failure mode after curing, crash stability and corrosion resistance;

US 2011/0024039 and U.S. Pat. No. 8,618,204 disclose one-component and two-component structural adhesives generally comprising an epoxy resin, a curing agent and a reactive liquid modifier or oil displacing agent. These structural adhesives are taught to exhibit good adherence to clean surfaces as well as to surfaces contaminated with hydrocarbon-containing material;

WO 2007/143646 discloses a structural adhesive comprising an epoxy resin, a polyester, a blowing agent and a curing agent. The structural adhesive is taught to exhibit good corrosion resistance due to the presence of the polyester; and

US 2007/0155879 discloses a two-component structural adhesive comprising a vinyl monomer, a soluble polymer and an acetylenic diol adhesion promoter. This structural adhesive is taught to exhibit an improvement in the ability to bond to a variety of metals.

Commercially available structural adhesives used by automotive manufacturers typically have a density greater than 1.2 g/cm³. If this density could be reduced, vehicle weight would also be reduced leading to an improvement in fuel economy or travel range for the vehicle. For example, electric vehicles manufactured today generally have a travel range of about 70-230 miles/charge which is significantly less than that for conventional gasoline- or diesel-powered vehicles. Since the power of a battery/charge is limited, there is a significant advantage to be gained by reducing the overall weight of the electric vehicle. However, attempts to reduce the density of structural adhesives used in automobile manufacturing have led to a corresponding reduction in their mechanical properties. Therefore, if an automotive structural adhesive could be developed having a reduced density without a reduction in mechanical performance, it could allow electric vehicles to reach travel ranges of, for example 400 miles or more/charge, which is similar to those for gasoline-powered vehicles.

### SUMMARY OF THE INVENTION

The present disclosure generally provides a syntactic structural adhesive comprising (a) an epoxy resin, (b) a low density particulate filler, and (c) a hardener where the syntactic structural adhesive, upon curing, exhibits at least the following well-balanced properties: (i) a density less than 1 g/cm³; (ii) a compression modulus greater than 500 MPa; and (iii) a lap shear strength greater than 750 psi.

The present disclosure also provides a method of forming a bonded joint between two substrates by providing the syntactic structural adhesive, applying the syntactic structural adhesive to a surface of at least one of the two substrates, joining the two substrates so that the syntactic structural adhesive is sandwiched between the two substrates and curing the syntactic structural adhesive to form a bonded joint between the two substrates.

The syntactic structural adhesive may be used as a structural adhesive in a variety of applications, such as in vehicle assembly including, but not limited to, the assembly of: watercraft vehicles; aircraft vehicles; railway vehicles; motorcraft vehicles, such as cars and motorcycles; and bicycles.

### DETAILED DESCRIPTION OF THE INVENTION

The present disclosure generally provides a syntactic structural adhesive comprising (a) an epoxy resin, (b) a low density particulate filler, and (c) a hardener. It has been surprisingly found when particular low density particulate fillers are combined with the epoxy resin and hardener and cured, the cured syntactic structural adhesive of the present disclosure exhibits a density that is 30%-60% less than conventional structural adhesives currently used in automotive bonding applications while also exhibiting similar, if not improved, mechanical properties and chemical properties, such as compression modulus, lap shear strength, adhesion to a number of substrates, temperature resistance and flame retardation. Accordingly, the syntactic structural adhesive of the present disclosure unexpectedly exhibits an excellent balance of physical, mechanical and thermal properties as compared to those for state of the art structural adhesives.

The following terms shall have the following meanings:

As used herein, the term “structural adhesive” refers to an adhesive which is capable of bonding substrates together by surface attachment (i.e., the adhesive in the cured state forms a portion of the bearing structure of the bonded substrates). The structural adhesive of the present disclosure encompasses a one-component adhesive and a multi-component adhesive, for example, a two-component adhesive.

The term “low density particulate filler” means a particulate filler having an average bulk density less than about 0.6 g/cm³, for example between 0.01 g/cm³-0.5 g/cm³, or between 0.1 g/cm³-0.4 g/cm³.

The term “high density particulate filler” means a particulate filler having an average bulk density of at least 1.5 g/cm³, or at least 2.0 g/cm³ or even at least 2.5 g/cm³.

The term “cure”, “cured” or similar terms, means that at least a portion of the polymerizable and/or crosslinkable components that form the syntactic structural adhesive are polymerized and/or crosslinked. Additionally, “curing” refers to subjecting the syntactic structural adhesive to curing conditions, such as, but not limited to, thermal curing, leading to the reaction of the reactive functional groups of the adhesive and resulting in polymerization and formation of a polymerizate. When the syntactic structural adhesive is subjected to curing conditions, and following polymerization and after reaction of most of the reactive groups has occurred, the rate of reaction of the remaining unreacted reactive groups will become progressively slower. The syntactic structural adhesive can be subjected to curing conditions until it is at least partially cured. The term “at least partially cured” means subjecting the syntactic structural adhesive to curing conditions, wherein reaction of at least a portion of the reactive groups of the adhesive occurs to form a polymerizate. The syntactic structural adhesive can also be subjected to curing conditions such that a substantially complete cure is attained and wherein further curing results in no significant further improvement in polymer properties, such as compressive strength.

The term “reactive” refers to a functional group capable of undergoing a chemical reaction with other functional groups spontaneously or upon the application of heat or by any other means known to those skilled in the art.

As used herein, the terms “on,” “onto,” “applied on,” “applied onto,” “formed on,” “deposited on,” “deposited onto,” mean formed, overlaid, deposited, or provided on, but not necessarily in contact with, a surface. For example, a syntactic structural adhesive “applied onto” a substrate does not preclude the presence of one or more other intervening coating layers of the same or different composition located between the syntactic structural adhesive and the substrate.

The term “substantially free” means, when used with reference to the substantial absence of a material in an adhesive formulation, that such a material is not present, or if present is an incidental impurity or by-product. In other words, the material does not affect the properties of the adhesive formulation.

The term “comprising” and derivatives thereof are not intended to exclude the presence of any additional component, step or procedure, whether or not the same is disclosed herein. In order to avoid any doubt, all compositions claimed herein through use of the term “comprising” may include any additional additive or compound, unless stated to the contrary. In contrast, the term, “consisting essentially of” if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or more than one (i.e. to at least one) of the grammatical object of the article. By way of example, “an epoxy resin” means one epoxy resin or more than one epoxy resin.

The phrases “in one aspect”, “according to one aspect” and the like generally mean the particular feature, structure, or characteristic following the phrase is included in at least one aspect of the present disclosure, and may be included in more than one aspect of the present disclosure. Importantly, such phrases do not necessarily refer to the same aspect.

If the specification states a component or feature “may”, “can”, “could”, or “might” be included or have a characteristic, that particular component or feature is not required to be included or have the characteristic.

According to one aspect, the present disclosure provides a syntactic structural adhesive comprising (a) an epoxy resin (b) a low density particulate filler and (c) a hardener where a resultant cured product formed by curing the syntactic structural adhesive contains at least the following well-balanced properties: (1) a density of less than 1.0 g/cm³; (2) a lap shear strength greater than 1000 psi; and (3) a compression modulus greater than 750 MPa.

In general, any epoxy-containing compound is suitable for use as the epoxy resin in the present disclosure, such as the epoxy-containing compounds disclosed in U.S. Pat. Nos. 5,476,748; 6,506,494; 6,632,893; 6,376,564; 6,348,513; 8,742,018; and 8,440,746, which are incorporated herein by reference. The epoxy resin may be solid or liquid and has at least one oxirane ring that is polymerizable by ring opening, i.e., an average epoxy functionality greater than one, and in some aspects at least two. The epoxy resin can be monomeric or polymeric, and aliphatic, cycloaliphatic, heterocyclic, aromatic, hydrogenated, or mixtures thereof. In some aspects, the epoxy resin contains more than 1.5 epoxy groups per molecule and preferably at least 2 epoxy groups per molecule.

According to one aspect, the epoxy resin may have a weight average molecular weight of about 150 to about 10,000 or about 180 to about 1,000. The molecular weight of the epoxy resin may also be selected to provide the desired properties of the cured adhesive.

In one aspect, the epoxy resin may be a polyglycidyl epoxy compound. The polyglycidyl epoxy compound may be a polyglycidyl ether, poly(β-methylglycidyl) ether, polyglycidyl ester or poly(β-methylglycidyl) ester. The synthesis and examples of polyglycidyl ethers, poly(β-methylglycidyl) ethers, polyglycidyl esters and poly(β-methylglycidyl) esters are disclosed in U.S. Pat. No. 5,972,563 which is incorporated herein by reference. For example, ethers may be obtained by reacting a compound having at least one free alcoholic hydroxyl group and/or phenolic hydroxyl group with a suitably substituted epichlorohydrin under alkaline conditions or in the presence of an acidic catalyst followed by alkali treatment. The alcohols may be, for example, acyclic alcohols, such as ethylene glycol, diethylene glycol and higher poly(oxyethylene) glycols, propane-1,2-diol, or poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylolpropane, bistrimethylolpropane, pentaerythritol and sorbitol. Suitable glycidyl ethers may also be obtained, however, from cycloaliphatic alcohols, such as 1,3- or 1,4-dihydroxycyclohexane, bis(4-hydroxycyclo-hexyl)methane, 2,2-bis(4-hydroxycyclohexyl)propane or 1,1-bis(hydroxymethyl)cyclohex-3-ene, or they may possess aromatic rings, such as N,N-bis(2-hydroxyethyl)aniline or p,p′-bis(2-hydroxyethylamino)diphenylmethane.

Particularly important representatives of polyglycidyl ethers or poly(β-methylglycidyl)ethers are based on monocyclic phenols, for example, on resorcinol or hydroquinone, on polycyclic phenols, for example, on bis(4-hydroxyphenyl)methane (Bisphenol F), 2,2-bis(4-hydroxyphenyl)propane (Bisphenol A), bis(4-hydroxyphenyl)sulfone (Bisphenol S), alkoxylated Bisphenol A, F or S, triol extended Bisphenol A, F or S, brominated Bisphenol A, F or S, hydrogenated Bisphenol A, F or S, glycidyl ethers of phenols and phenols with pendant groups or chains, on condensation products, obtained under acidic conditions, of phenols or cresols with formaldehyde, such as bisphenol A novolaks and cresol novolaks, or on siloxane diglycidyls.

Polyglycidyl esters and poly(β-methylglycidyl)esters may be produced by reacting epichlorohydrin or glycerol dichlorohydrin or β-methylepichlorohydrin with a polycarboxylic acid compound. The reaction is expediently carried out in the presence of bases. The polycarboxylic acid compounds may be, for example, glutaric acid, adipic acid, pimelic acid, suberic acid, azelaic acid, sebacic acid or dimerized or trimerized linoleic acid. Likewise, however, it is also possible to employ cycloaliphatic polycarboxylic acids, for example tetrahydrophthalic acid, 4-methyltetrahydrophthalic acid, hexahydrophthalic acid or 4-methylhexahydrophthalic acid. It is also possible to use aromatic polycarboxylic acids such as, for example, phthalic acid, isophthalic acid, trimellitic acid or pyromellitic acid, or else carboxyl-terminated adducts, for example of trimellitic acid and polyols, for example glycerol or 2,2-bis(4-hydroxycyclohexyl)propane, may be used.

In another aspect, the epoxy resin may be a non-glycidyl epoxy compound. Non-glycidyl epoxy compounds may be linear, branched, or cyclic in structure. For example, there may be included one or more epoxide compounds in which the epoxide groups form part of an alicyclic or heterocyclic ring system. Others include an epoxy-containing compound with at least one epoxycyclohexyl group that is bonded directly or indirectly to a group containing at least one silicon atom. Examples are disclosed in U.S. Pat. No. 5,639,413, which is incorporated herein by reference. Still others include epoxides which contain one or more cyclohexene oxide groups and epoxides which contain one or more cyclopentene oxide groups.

Particular examples of non-glycidyl epoxy compounds include the following: difunctional non-glycidyl epoxide compounds in which the epoxide groups form part of an alicyclic or heterocyclic ring system: bis(2,3-epoxycyclopentyl)ether, 1,2-bis(2,3-epoxycyclopentyloxy)ethane, 3,4-epoxycyclohexyl-methyl 3,4-epoxycyclohexanecarboxylate, 3,4-epoxy-6-methyl-cyclohexylmethyl 3,4-epoxy-6-methylcyclohexanecarboxylate, di(3,4-epoxycyclohexylmethyl)hexanedioate, di(3,4-epoxy-6-methylcyclohexylmethyl) hexanedioate, ethylenebis(3,4-epoxycyclohexanecarboxylate) and ethanediol di(3,4-epoxycyclohexylmethyl.

In some particular aspects, the difunctional non-glycidyl epoxy compounds include cycloaliphatic difunctional non-glycidyl epoxies, such as 3,4-epoxycyclohexyl-methyl 3′,4′-epoxycyclohexanecarboxylate and 2,2′-bis-(3,4-epoxycyclohexyl)-propane, with the former being most preferred.

In yet another aspect, the epoxy resin may be a poly(N-glycidyl) compound or poly(S-glycidyl) compound. Poly(N-glycidyl) compounds are obtainable, for example, by dehydrochlorination of the reaction products of epichlorohydrin with amines containing at least two amine hydrogen atoms. These amines may be, for example, n-butylamine, aniline, toluidine, m-xylylenediamine, bis(4-aminophenyl)methane or bis(4-methylaminophenyl)methane. Other examples of poly(N-glycidyl) compounds include N,N′-diglycidyl derivatives of cycloalkyleneureas, such as ethyleneurea or 1,3-propyleneurea, and N,N′-diglycidyl derivatives of hydantoins, such as of 5,5-dimethylhydantoin. Examples of poly(S-glycidyl) compounds are di-S-glycidyl derivatives derived from dithiols, for example ethane-1,2-dithiol or bis(4-mercaptomethylphenyl)ether.

It is also possible to employ epoxy resins in which the 1,2-epoxide groups are attached to different heteroatoms or functional groups. Examples include the N,N,O-triglycidyl derivative of 4-aminophenol, the glycidyl ether/glycidyl ester of salicylic acid, N-glycidyl-N′-(2-glycidyloxypropyl)-5,5-dimethylhydantoin or 2-glycidyloxy-1,3-bis(5,5-dimethyl-1-glycidylhydantoin-3-yl)propane.

Other epoxide derivatives may also be employed, such as vinyl cyclohexene dioxide, limonene dioxide, limonene monoxide, vinyl cyclohexene monoxide, 3,4-epoxycyclohexlmethylacrylate, 3,4-epoxy-6-methylcyclohexylmethyl 9,10-epoxystearate, and 1,2-bis(2,3-epoxy-2-methylpropoxy)ethane.

Additionally, the epoxy resin may be a pre-reacted adduct of an epoxy resin, such as those mentioned above, with compounds having a free hydrogen that is reactive with an epoxy group. Typically, such reactive hydrogens are found in carboxylic acid groups, aromatic hydroxyl groups, amino groups, and sulfhydryl groups.

In one particular aspect, the syntactic structural adhesive may contain only one epoxy resin while in other aspects, the syntactic structural adhesive may contain a mixture of epoxy resins.

According to another aspect, the epoxy resin comprises at least one multifunctional epoxy resin. The multifunctional epoxy resin may be a difunctional epoxy resin, a trifunctional epoxy resin, a tetrafunctional epoxy resin or a mixture thereof.

Examples of difunctional epoxy resins include, but are not limited to, diglycidyl ethers of bisphenol A-based materials (e.g., Epon™ 828 epoxy resin, D.E.R.™ 331 and D.E.R.™ 661 epoxy resins, Tactix® 123 epoxy resin, and Araldite® 184 epoxy resin).

Examples of trifunctional epoxy resins include, but are not limited to, triglycidyl ether of aminophenol, (e.g., Araldite® MY 0510, MY 0500, MY 0600 and MY 0610 epoxy resins).

Examples of tetrafunctional epoxy resins include, but are not limited to, tetraglycidyl ether of methylene dianiline (e.g., Araldite® MY 9655 epoxy resin), tetraglycidyl diaminodiphenyl methane (e.g., Araldite® MY-721, MY-720, 725, MY 9663, 9634 and 9655 epoxy resins) and sorbitol polyglycidyl ether (e.g., EJ-190 epoxy resin and ERISYS® GE-60 epoxy resin).

In yet another aspect, the epoxy resin may be comprised of at least one multifunctional epoxy resin together with at least one monofunctional epoxy resin. Examples of such monofunctional epoxy resins include, but are not limited to, phenyl glycidyl ether, cresyl glycidyl ether, para-t-butyl phenyl glycidyl ether, C₆-C₂₈ alkyl glycidyl ethers, C₆-C₂₈ fatty acid glycidyl esters and C₆-C₂₈ alkylphenol glycidyl ethers.

The amount of epoxy resin used in the syntactic structural adhesive may depend on the targeted molecular weight and epoxy functionality. According to some aspects, the syntactic structural adhesive may include the epoxy resin in an amount of from about 10 wt. % to about 90 wt. %, based on the total weight of the syntactic structural adhesive. In other aspects, the syntactic structural adhesive may include the epoxy resin in an amount of from about 12.5 wt. % by weight to about 75 wt. %, or from about 15 wt. % to about 60 wt. %, or from about 17.5 wt. % to about 50 wt. %, or even from about 20 wt. % to about 40 wt. %, where the % by weight is based on the total weight of the syntactic structural adhesive.

The syntactic structural adhesive also contains a low density particulate filler. In some aspects, the low density particulate filler includes, but is not limited to, a naturally occurring mineral, a manmade material, silica particles, a lightweight waste product and mixtures thereof. Examples of such fillers generally include, but are not limited to, pearlite, vermiculite, hollow microspheres and microballons made from glass, ceramics, carbon, metal or synthetic resins, fumed silica, colloidal silicas, precipitated silicas, silica gels, ground up tires, ground up wood fibers, ground up cellulose fibers and ground up polymer foams made from a variety of different polymers including polyesters, polyamides, polystyrenes, polyurethanes and polyisocyanurates.

In other aspects, the low density particulate filler may include irregularly shaped particles or spherically shaped particles or mixtures thereof.

Irregularly shaped particles include particles which lack a uniform spherical or platelet shape. Irregularly shaped particles are typically obtained through precipitation, grinding or pulverizing, or are comprised of fused or aggregated primary particles, to yield particles with irregular shape or surface texture. The irregularly shaped particles, in general, have a particle size of less than about 300 μm, and even less than about 100 μm.

Spherical particles have or substantially have the shape of a sphere and may be hollow or solid. The spherical particles, in general, have a particle size of less than about 300 μm, and even less than about 100 μm.

According to one particular aspect, the low density particulate filler includes spherical hollow particles, such as for example hollow inorganic particles or hollow organic particles, for example inorganic microspheres or organic microspheres, or combinations thereof. The hollow part of the particles may be filled by a gas or mixture of gases, a liquid or mixture of liquids, or a mixture of one or more gases and one or more liquids, or may be a vacuum.

The inorganic microspheres may be selected from a variety of materials including by way of example glass, silica, ceramic (including sol-gel derived), zirconia and combinations thereof. The inorganic particles, in some aspects, may comprise silica, a soda-lime borosilicate glass, a silica-alumina ceramic, an alkali alumino silicate ceramic type, aluminum oxide or combinations thereof. The inorganic microspheres may be selected so that they allow the cured syntactic structural adhesive to exhibit low density without compromising compressive strength. Thus, in one particular aspect the inorganic microspheres will have a density of less than 0.5 g/cm³ and at least 85 wt. % and even at least 90 wt. % of the inorganic microspheres have a collapse strength of at least 2500 psi or at least 4000 psi, where the wt. % is based on the total weight of the inorganic microspheres. The average particle size for the inorganic microspheres may range from between about 1 μm to about 300 μm, or from between about 10 μm to about 100 μm.

In another aspect, the inorganic microspheres are glass microspheres or microbubbles such as those described in U.S. Pat. No. 3,365,315, the contents of which are incorporated herein by reference. The walls of these microspheres are made by expanding solid glass particles at temperatures above 1000° C. to form tiny hollow spheroids having an apparent density in the range of about 0.14 to about 0.38 g/cm³, a wall thickness of about 0.5 to 2.0 microns, and an average particle size of about 60 microns. Other glassy or inorganic microspheres of synthetic fused water-insoluble alkali metal silicate-based glass which may be used are described in U.S. Pat. No. 3,230,184, and microspheres made of sodium silicate which are useful in the present disclosure are described in U.S. Pat. No. 3,030,215, the contents of which are incorporated herein by reference. Microspheres prepared from heat expanded natural minerals such as perlite, volcanic ash, fly ash and vermiculite may also be used. Commercially available inorganic microspheres include those under the trade designation Scotchlite™ glass bubbles, Q-CEL® inorganic microspheres and EXTENDOSPHERES® ceramic microspheres.

Organic microspheres include polymeric microspheres made of organic polymers, i.e., materials comprising repeating units derived from monomers containing at least one unsaturated carbon-carbon bond. Typical examples of such polymers include, but are not limited to, acrylonitrile polymers or copolymers, acrylate polymers or copolymers, vinylidene polymers or copolymers, polyacetate polymers or copolymers, polyester polymers or copolymers, vinylidenechloride/acrylonitrile copolymers, acrylate/acrylonitrile copolymers and combinations thereof.

In addition, the organic microspheres may be unexpanded or preexpanded organic hollow microspheres. Unexpanded organic hollow microspheres, sometimes referred to as expandable organic microballoons, are available, for example, under the trade designations EXPANCEL® and MICROPEARL® microspheres. Such microspheres comprise a thermoplastic shell entrapping a volatile liquid, such as a hydrocarbon (e.g., ethane, ethylene, propane, propene, butane, isobutane, neopentane, acetylene, hexane, heptane and isopentane), a chlorofluorocarbon, a tetraalkyl silane (e.g., tetramethyl silane, trimethylethyl silane, trimethylisopropyl silane, and trimethyl n-propyl silane) as well as perfluorocarbons. When subjected to heat or similar activation energy, the microspheres dramatically expand to many times their original size and retain this size after the activation energy is removed. The thermoplastic shell may include, but is not limited to, polyvinylidene-polyacrylonitrile, polyvinylidene-polyacrylonitrile-polymethylmethacrylate, and polystyrene-polyacrylonitrile copolymers.

Preexpanded organic microspheres are previously expanded through the use of an organic blowing agent (e.g., a hydrocarbon such as described above including pentane, isopentane, butane, or mixtures of these) or an inorganic blowing agent (e.g., air, carbon dioxide, nitrogen, argon, or mixtures of these) to provide a particle having a larger size but a lower density. For example, the preexpanded organic microspheres can be comprised of from 1% to 99%, 25% to 95% or 50% to 90% air by volume. The preexpanded microspheres can be partially expanded (i.e., capable of further expansion) or fully expanded. For example, the microspheres can be greater than 50% expanded, greater than 60% expanded, greater than 70% expanded, greater than 80% expanded, greater than 90% expanded or 100% (i.e., fully) expanded as determined based on the density of the microspheres.

The preexpanded organic microspheres described herein can be derived from expandable polymers, including, for example, thermoplastic polymers. Examples include polystyrene (e.g., free-radical-polymerized glass-clear polystyrene (GPPS) or anionically polymerized polystyrene (APS)), styrene-based-copolymers (e.g., styrene-maleic anhydride copolymers, styrene-butadiene copolymers, styrene-α-methylstyrene copolymers, acrylonitrile-butadiene-styrene (ABS) copolymers, styrene-acrylonitrile (SAN) copolymers, styrene-methyl methacrylate copolymers, acrylonitrile-styrene-acrylate (ASA) copolymers, methacrylate-butadiene-styrene (MBS) copolymers, or methyl methacrylate-acrylonitrile-butadiene-styrene (MABS) copolymers), polyethylene (e.g., low density polyethylene, high density polyethylene, and linear low-density polyethylene), polypropylene, polyesters, polyvinylchloride, cellulose acetate, copolymers of vinyl and vinylidene chloride, polyacrylic esters, polymethacrylic esters, thermoplastic polyurethane and polyamides, and mixtures of these. Further examples of suitable preexpanded microspheres include those derived from polyphenylene oxide, polystyrene-polyphenylene oxide blends, polyoxymethylene, poly(methyl methacrylate), methyl methacrylate copolymers, ethylene-propylene copolymers (e.g., random and block), ethylene-vinyl acetate copolymers, polycarbonate, polyethylene terephthalate, aromatic polyester/polyether glycol block copolymer, polyethylene and polymerized vinyl aromatic resins. Examples of vinyl aromatic resins include the solid homopolymers of styrene, vinyltoluene, vinylxylene, ethylvinylbenzene, isopropylstyrene, t-butyl styrene, chlorostyrene, dichlorostyrene, fluorostyrene, bromostyrene; the solid copolymers of two or more monovinyl aromatic compounds, and the solid copolymers of one or more of monovinyl aromatic compounds and a copolymerizable olefinic compound (e.g., acrylonitrile, methyl methacrylate, or ethyl acrylate).

Such preexpanded organic microspheres are commercially available, for example, under the trade designation DUALITE® microspheres, GRAFGUARD® expandable graphite particles and STYROPOR® microspheres.

In one aspect, only inorganic microspheres described above are included in the syntactic structural adhesive, while in other aspects a combination of the inorganic microspheres and organic microspheres described above are included in the syntactic structural adhesive.

The concentration and the nature of the low density particulate fillers for use in the syntactic structural adhesive may be selected such that the density of the syntactic structural adhesive is less than 1 g/cm³, or less than 0.8 g/cm³, or even between about 0.5 g/cm³ and 0.75 g/cm³ or still even between about 0.55 g/cm³ and 0.65 g/cm³.

Thus, in one aspect, the syntactic structural adhesive of the present disclosure may contain from about 1 wt. % to about 80 wt. %, or from about 2 wt. % to about 60 wt. %, or from about 5 wt. % to about 50 wt. %, or from about 7.5 wt. % to about 45 wt. %, or from about 10 wt. % to about 40 wt. %, or even from about 15 wt. % to about 30 wt. % of the low density particulate filler, based on the total weight of the syntactic structural adhesive.

According to another aspect, hardening of the syntactic structural adhesive may be accomplished by the addition of any chemical material(s) known in the art for curing such adhesives. Such materials are compounds that have a reactive moiety that can react with the epoxy group of the epoxy resin and are referred to herein as “hardeners” but also include the materials known to those skilled in the art as curing agents, curatives, activators, catalysts or accelerators. While certain hardeners promote curing by catalytic action, others participate directly in the reaction of the resin and are incorporated into the thermoplastic polymeric network formed by condensation, chain-extension and/or cross-linking of the resin. Depending on the hardener, heat may or may not be required for significant reaction to occur. Hardeners for the epoxy resin include, but are not limited to aromatic amines, cyclic amines, aliphatic amines, alkyl amines, polyether amines, including those polyether amines that can be derived from polypropylene oxide and/or polyethylene oxide, acid anhydrides, carboxylic acid amides, polyamides, polyphenols, cresol and phenol novolac resins, imidazoles, guanidines, substituted guanidines, substituted ureas, melamine resins, guanamine derivatives, tertiary amines, Lewis acid complexes, such as boron trifluoride and boron trichloride and polymercaptans. Any epoxy-modified amine products, Mannich modified products, and Michael modified addition products of the hardeners described above may also be used. All of the above mentioned curatives may be used either alone or in any combination.

In one particular aspect, the hardener is a multifunctional amine. The term “multifunctional amine” as used herein refers to an amine having at least two primary and/or secondary amino groups in a molecule. For example, the multifunctional amine may be an aromatic multifunctional amine having two amino groups bonded to benzene at any one of ortho, meta and para positional relations, such as phenylenediamine, xylenediamine, 1,3,5-triaminobenzene, 1,2,4-triaminobenzene and 3,5-diaminobenzoic acid, an aliphatic multifunctional amine such as ethylenediamine and propylenediamine, an alicyclic multifunctional amine such as 1,2-diaminocyclohexane, 1,4-diaminocyclohexane, piperazine, 1,3-bispiperidylpropane and 4-aminomethylpiperazine, and the like. These multifunctional amines may be used alone or in a mixture thereof.

Exemplary aromatic amines include, but are not limited to 1,8 diaminonaphthalene, m-phenylenediamine, diethylene toluene diamine, diaminodiphenylsulfone, diaminodiphenylmethane, diaminodiethyldimethyl diphenylmethane, 4,4′-methylenebis(2,6-diethylaniline), 4,4′-methylenebis(2-isopropyl-6-methylaniline), 4,4′-methylenebis(2,6-diisopropylaniline), 4,4′-[1,4-phenylenebis(1-methyl-ethylindene)]bisaniline, 4,4′-[1,3-phenylenebis(1-methyl-ethylindene)]bisaniline, 1,3-bis(3-aminophenoxy)benzene, bis-[4-(3-aminophenoxy)phenyl]sulfone, bis-[4-(4-aminophenoxy)phenyl]sulfone, 2,2′-bis[4-(4-aminophenoxy)phenyl]propane. Furthermore, the aromatic amines may include heterocyclic multifunctional amine adducts as disclosed in U.S. Pat. Nos. 4,427,802 and 4,599,413, which are both hereby incorporated by way of reference in their entirety.

Examples of cyclic amines include, but are not limited to bis(4-amino-3-methyldicyclohexyl)methane, diaminodicyclohexylmethane, bis(aminomethyl)cyclohexane, N-aminoethylpyrazine, 3,9-bis(3-aminopropyl)-2,4,8,10-tetraoxaspiro(5,5)undecane, m-xylenediamine, isophoronediamine, menthenediamine, 1,4-bis(2-amino-2-methylpropyl) piperazine, N,N′-dimethylpiperazine, pyridine, picoline, 1,8-diazabicyclo[5,4,0]-7-undecene, benzylmethylamine, 2-(dimethylaminomethyl)-phenol, 2-methylimidazole, 2-phenylimidazole, and 2-ethyl-4-methylimidazole.

Exemplary aliphatic amines include, but are not limited to diethylenetriamine, triethylenetetramine, tetraethylenepentamine, 3-(dimethylamino)propylamine, 3-(diethylamino)-propylamine, 3-(methylamino)propylamine, tris(2-aminoethyl)amine; 3-(2-ethylhexyloxy)propylamine, 3-ethoxypropylamine, 3-methoxypropylamine, 3-(dibutylamino)propylamine, and tetramethyl-ethylenediamine, ethylenediamine, 3,3′-iminobis(propylamine), N-methyl-3,3′-iminobis(propylamine), allylamine, diallylamine, triallylamine, polyoxypropylenediamine, and polyoxypropylenetriamine.

Exemplary alkyl amines include, but are not limited to methylamine, ethylamine, propylamine, isopropylamine, butylamine, sec-butylamine, t-butylamine, n-octylamine, 2-ethylhexylamine, dimethylamine, diethylamine, dipropylamine, diisopropylamine, dibutylamine, di-sec-butylamine, di-t-butylamine, di-n-octylamine and di-2-ethylhexylamine.

Exemplary acid anhydrides include, but are not limited to, cyclohexane-1,2-dicarboxylic acid anhydride, 1-cyclohexene-1,2-dicarboxylic acid anhydride, 2-cyclohexene-1,2-dicarboxylic acid anhydride, 3-cyclohexene-1,2-dicarboxylic acid anhydride, 4-cyclohexene-1,2-dicarboxylic acid anhydride, 1-methyl-2-cyclohexene-1,2-dicarboxylic acid anhydride, 1-methyl-4-cyclohexene-1,2-dicarboxylic acid anhydride, 3-methyl-4-cyclohexene-1,2-dicarboxylic acid anhydride, 4-methyl-4-cyclohexene-1,2-dicarboxylic acid anhydride, dodecenylsuccinic anhydride, succinic anhydride, 4-methyl-1-cyclohexene-1,2-dicarboxylic acid anhydride, phthalic anhydride, hexahydrophthalic anhydride, nadic methyl anhydride, dodecenylsuccinic anhydride, tetrahydrophthalic anhydride, maleic anhydride, pyromellitic dianhydride, trimellitic anhydride, benzophenonetetracarboxylic dianhydride, bicyclo[2.2.1]hept-5-ene-2,3-dicarboxylic anhydride, methylbicyclo[2.2.1]hept-5-ene-2,3-dicarboxylic anhydride, bicyclo[2.2.1]hept-5-ene-2,3-dicarboxylic anhydride, dichloromaleic anhydride, chlorendic anhydride, tetrachlorophthalic anhydride and any derivative or adduct thereof.

Exemplary imidazoles include, but are not limited to, imidazole, 1-methylimidazole, 2-methylimidazole, 2-ethylimidazole, 2-isopropylimidazole, 2-n-propylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-methylimidazole, 1-benzyl-2-phenylimidazole, 1-isopropyl-2-methylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 2-phenyl-4-methyl-5-hydroxymethylimidazole, 2-phenylimidazole, 2-phenyl-4,5-dihydroxymethylimidazole, 1,2-phenyl-4-methyl-5-hydroxymethylimidazole, 1-dodecyl-2-methylimidazole and 1-cyanoethyl-2-phenyl-4,5-di(2-cyanoethoxy)methylimidazole.

Exemplary substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine and cyanoguanidine (dicyandiamide). Representatives of guanamine derivatives which may be mentioned are alkylated benzoguanamine resins, benzoguanamine resins or methoxymethylethoxymethylbenzoguanamine. Substituted ureas may include p-chlorophenyl-N,N-dimethylurea (monuron), 3-phenyl-1,1-dimethylurea (fenuron) or 3,4-dichlorophenyl-N,N-dimethylurea (diuron).

Exemplary tertiary amines include, but are not limited to, trimethylamine, tripropylamine, triisopropylamine, tributylamine, tri-sec-butylamine, tri-t-butylamine, tri-n-octylamine, N,N-dimethylaniline, N,N-dimethyl-benzylamine, pyridine, N-methylpiperidine, N-methylmorpholine, N,N-dimethylaminopyridine, derivatives of morpholine such as bis(2-(2,6-dimethyl-4-morpholino)ethyl)-(2-(4-morpholino)ethyl)amine, bis(2-(2,6-dimethyl-4-morpholino)ethyl)-(2-(2,6-diethyl-4-morpholino)ethyl)amine, tris(2-(4-morpholino)ethyl)amine, and tris(2-(4-morpholino)propyl)amine, diazabicyclooctane (DABCO), and heterocyclic compounds having an amidine bonding such as diazabicyclono.

Amine-epoxy adducts are well-known in the art and are described, for example, in U.S. Pat. Nos. 3,756,984, 4,066,625, 4,268,656, 4,360,649, 4,542,202, 4,546,155, 5,134,239, 5,407,978, 5,543,486, 5,548,058, 5,430,112, 5,464,910, 5,439,977, 5,717,011, 5,733,954, 5,789,498, 5,798,399 and 5,801,218, each of which is incorporated herein by reference in its entirety. Such amine-epoxy adducts are the products of the reaction between one or more amine compounds and one or more epoxy compounds. Preferably, the adduct is a solid which is insoluble in the epoxy resin at room temperature, but which becomes soluble and functions as an accelerator to increase the cure rate upon heating. While any type of amine can be used (with heterocyclic amines and/or amines containing at least one secondary nitrogen atom being preferred), imidazole compounds are particularly preferred. Illustrative imidazoles include 2-methyl imidazole, 2,4-dimethyl imidazole, 2-ethyl-4-methyl imidazole, 2-phenyl imidazole and the like. Other suitable amines include, but are not limited to, piperazines, piperidines, pyrazoles, purines, and triazoles. Any kind of epoxy compound can be employed as the other starting material for the adduct, including mono-functional, and multi-functional epoxy compounds such as those described previously with regard to the epoxy resin component.

In one aspect, the syntactic structural adhesive of the present disclosure may contain up to about 90 wt. % of hardener, based on the total weight of the syntactic structural adhesive. In other aspects, the syntactic structural adhesive may contain up to about 80 wt. %, or up to about 70 wt. %, or up to about 60 wt. %, or up to about 50 wt. % or up to about 40 wt. % or up to about 30 wt. % or up to about 20 wt. % or even up to about 10 wt. % of the hardener, based on the total weight of the syntactic structural adhesive.

In a further aspect, the syntactic structural adhesive may optionally contain a flame retardant. The syntactic structural adhesives of the present disclosure may include from about 5 wt. % to about 60 wt. % weight of a flame retardant that consists of a mixture of (i) a compound selected from the group of an alkaline earth metal hydroxide and an aluminum group hydroxide and (ii) at least one phosphorous-containing material.

The group of compounds selected from alkaline earth metal hydroxides and aluminum group hydroxides are often referred to as smoke suppressants. Examples of such smoke suppressants include, but are not limited to, aluminum trihydrate, aluminum oxide trihydrate (sometimes also referred to as aluminum hydroxide) and magnesium hydroxide.

The phosphorous-containing material may be selected from elemental red phosphorous, melamine phosphate, dimelamine phosphate, melamine pyrophosphate and inorganic phosphinates such as, for example, aluminum phosphinates.

According to some aspects, it may be advantageous to include a multi-functional acrylate accelerator in the syntactic structural adhesive. As used herein the term “multi-functional acrylate” refers to compounds that have at least two acrylate functionalities that are reactive, under the conditions used to cure the syntactic structural adhesive, with at least one of the compounds involved in the curing reaction or formed by the curing reaction. As used herein, the term “acrylate functionality” refers to a functional group having the general structure

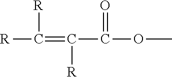

where R may be any group which does not substantially interfere with or prevent reaction of the multi-functional acrylate compound with the epoxy resin. In some aspects, R is independently H or a substituted or unsubstituted alkyl, aryl, oxyalkyl, arylalkyl, or oxyalkylaryl. In highly preferred aspects, each R is H.

Multi-functional acrylates may include aliphatic urethane acrylates, epoxy acrylates, melamine acrylates, methacrylates and ethylenically unsaturated monomers and resins. Particular examples include, but are not limited to, trimethylol propane triacrylate, 1,6-hexanediol diacrylate, hexafunctional urethane acrylate, hexafunctional epoxy acrylate, tripropylene glycol diacrylate, ethoxylated trimethylolpropane triacrylate, pentaerythritol triacrylate, dipentaerythritol pentaacrylate, propoxylated neopentyl glycol diacrylate and mixtures thereof.

The syntactic structural adhesive may include the optional multi-functional acrylate accelerator in an amount of about 0.5 wt. % to about 25 wt. %, based on the total weight of the syntactic structural adhesive. In other aspects, the syntactic structural adhesive may include the optional multi-functional acrylate accelerator in an amount of about 1 wt. % to about 20 wt. %, or from about 2 wt. % to about 17.5 wt. % or even from about 3 wt. % to about 15 wt. %, based on the total weight of the syntactic structural adhesive.

In yet another aspect, the syntactic structural adhesive may also contain one or more other additives which are useful for their intended uses. For example, the optional additives useful in the syntactic structural adhesive may include, but are not limited to, diluents, stabilizers, surfactants, flow modifiers, release agents, matting agents, degassing agents, toughening agents (e.g., carboxyl terminated liquid butadiene acrylonitrile rubber (CTBN), acrylic terminated liquid butadiene acrylonitrile rubber (ATBN), epoxy terminated liquid butadiene acrylonitrile rubber (ETBN), liquid epoxy resin (LER) adducts of elastomers and preformed core-shell rubbers), curing initiators, curing inhibitors, wetting agents, processing aids, fluorescent compounds, UV stabilizers, antioxidants, impact modifiers, corrosion inhibitors, adhesion promoters, high density particulate fillers (e.g., various naturally occurring clays, such as kaolin, bentonite, montmorillonite or modified montmorillonite, attapulgate and Buckminsterfuller's earth; other naturally occurring or naturally derived materials, such as mica, calcium carbonate and aluminum carbonate; various oxides, such as ferric oxide, titanium dioxide, calcium oxide and silicon dioxide (e.g., sand); brick dust; various man-made materials, such as precipitated calcium carbonate; and various waste materials such as crushed blast furnace slag) and mixtures thereof. In one particular aspect, the syntactic structural adhesive is substantially free of blowing agents or tougheners or tertiary amines or dicyandiamide or polyester or any combinations thereof.

When present, the amount of additives included in the syntactic structural adhesive may be at least about 0.5% by weight, or at least 2% by weight, or at least 5% by weight or at least 10% by weight, based on the total weight of the syntactic structural adhesive. In other aspects, the amount of additives included in the syntactic structural adhesive may be no more than about 30 wt. %, or no more than 25 wt. % by weight, or no more than 20 wt. % or no more than 15 wt. %, based on the total weight of the syntactic structural adhesive.

The syntactic structural adhesive may be prepared by stirring and mixing the materials in a state where the materials are heated if needed, without particular limitation. In some aspects, the syntactic structural adhesive of the present disclosure may be a multi-component type (e.g., two-component type) adhesive where at least two of the components of the syntactic structural adhesive are prepared separately and packaged in separate containers (or vessels) and the syntactic structural adhesive is obtained by mixing the two or more separately prepared components together, in some aspects immediately prior to use. For example, according to one aspect the two-components include a Part A which is the epoxy resin and a Part B which is the hardener with the low density particulate filler and the optional materials added to Part A, Part B or Part A and Part B. Part A and Part B are mixed together at a predetermined ratio before use. The amounts of Part A and Part B mixed together will depend upon the desired epoxy to hardener reactive hydrogen molar ratio in the syntactic structural adhesive. In some aspects, Part A and Part B may be mixed at a weight ratio of about 0.1:1 to about 3:1, or about 0.2:1 to about 2:1, or about 0.5:1 to about 1.5:1, or even still about 1:1. In other aspects, the epoxy resin and hardener are combined so that the ratio of the number of the equivalents of reactive hydrogens in the hardener to the number of the equivalents of epoxides present in the syntactic structural adhesive ranges from about 0.2 to about 2, or from about 0.3 to about 1.5, or even from about 0.4 to about 1, or even still from about 0.5 to about 0.85, and in some cases from about 0.6 to about 0.8, and in further cases from about 0.65 to about 0.75.

According to one particular aspect, the syntactic structural adhesive is a two-component adhesive where: Part A includes from about 10 wt. % to about 90 wt. % of an epoxy resin, from about 5 wt. % to about 80 wt. % of a low density particulate filler and from about 5 wt. % to about 60 wt. % of a flame retardant, where the wt. % is based on the total weight of Part A; and, Part B includes from about 10 wt. % to about 90 wt. % of a hardener, from about 5 wt. % to about 80 wt. % of a low density particulate filler and from about 5 wt. % to about 60 wt. % of a flame retardant, where the wt. % is based on the total weight of Part B, and where upon mixing Part A and Part B together to form the syntactic structural adhesive and curing provides a cured material that exhibits at least the following well-balanced properties: (i) a density less than 1 g/cm³; (ii) a compression modulus greater than 500 MPa; and (iii) a lap shear strength greater than 750 psi. According to yet another particular aspect, Part A can include from about 15 wt. % to about 70 wt. % of an epoxy resin, from about 10 wt. % to about 30 wt. % of a low density particulate filler, from about 3 wt. % to about 20 wt. % of a multifunctional acrylate and from about 5 wt. % to about 40 wt. % of a flame retardant, where the wt. % is based on the total weight of Part A; and, Part B includes from about 15 wt. % to about 80 wt. % of a hardener, from about 10 wt. % to about 30 wt. % of a low density particulate filler and from about 5 wt. % to about 40 wt. % of a flame retardant, where the wt. % is based on the total weight of Part B.

In still other aspects, there is provided a kit of parts suitable for preparing the syntactic structural adhesive. Such kit comprises at least two parts, a Part A comprising the epoxy resin and a Part B comprising the hardener, and where at least one of the Parts A and B of the kit further comprises the low density particulate filler. In some aspects, the low density particulate filler can be included in Part A and in Part B. The Parts of the kit may be packaged and sold in cartridges, such as dual cartridges similar to a caulk gun, or in drums or large containers and then dispersed using meter-mix equipment, or in glass or film capsules.

In still further aspects, the syntactic structural adhesive may be a “one-component” syntactic structural adhesive in which all of the materials are premixed in a container and stored and where the reactive components do not readily react at ambient or low temperature conditions, such as about −18° C., but instead only react upon activation by an external energy source. After all materials have been combined and mixed, the mixture can be degassed and then sealed in a closed container. There is no criticality to the order of mixture, i.e., the materials may be admixed in any order. In the absence of activation from the external energy source, the syntactic structural adhesive will remain largely unreacted for long periods of time until use. It has been surprisingly found that the one-component syntactic structural adhesives of the present disclosure are stable (i.e., remain largely unreacted) for at least 18 months when stored at low temperature conditions, such as about −18° C. External energy sources that may be used to promote the curing reaction include, for example, radiation (i.e., actinic radiation such as ultraviolet light) and/or heat. As further defined herein, “ambient conditions” generally refer to temperatures of about 10° C. to about 25° C., while low temperature conditions are temperatures that are lower than 0° C. and above −40° C.

According to one particular aspect, the syntactic structural adhesive is a one-component syntactic structural adhesive comprising from about 10 wt. % to about 70 wt. % of an epoxy resin, from about 2 wt. % to about 50 wt. % of a low density particulate filler and up to about 45 wt. % of a hardener, where the wt. % is based on the total weight of the syntactic structural adhesive, and wherein the one-component syntactic structural adhesive, upon curing, exhibits at least the following well-balanced properties: (i) a density less than 1 g/cm³; (ii) a compression modulus greater than 500 MPa; and (iii) a lap shear strength greater than 750 psi. In still another particular aspect the one-component syntactic structural adhesive comprises from about 20 wt. % to about 40 wt. % of an epoxy resin, from about 10 wt. % to about 30 wt. % of a low density particulate filler and up to about 30 wt. % of a hardener and optionally up to about 40 wt. % of a flame retardant, where the wt. % is based on the total weight of syntactic structural adhesive.

The stirring/mixing method for preparing the syntactic structural adhesive is not particularly limited. For example, there can be used a known or customary stirring/mixing unit such as a mixer (e.g., a dissolver, a homogenizer or a static mixer), a kneader, a roll, a bead mill, or a planetary stirring apparatus or even hand mixed. If necessary, the mixture after stirring and mixing may be subjected to defoam in a vacuum.

The syntactic structural adhesive of the present disclosure may be used to supplement or completely eliminate a weld and/or mechanical fastener by applying the syntactic structural adhesive between two or more substrates to be joined and curing the syntactic structural adhesive to form a bonded joint. The syntactic structural adhesive may be applied to any substrate. Substrates include, but are not limited to, a metal, carbon fiber, glass, polymeric material, such as hard plastics, cellulosic-containing material, epoxy fiber composite and mixtures thereof. The metals include, but are not limited to, titanium, ferrous metals, aluminum, aluminum alloys, copper, and other metal and alloy substrates. Non-limiting examples of steels include cold rolled steel, galvanized (zinc coated) steel, electrogalvanized steel, stainless steel, pickled steel, zinc-iron alloy such as GALVANNEAL® steel, and combinations thereof. Examples of cellulosic-containing materials include paper, paperboard, cardboard, plywood and pressed fiber boards, hardwood, softwood, wood veneer, particleboard, chipboard, oriented strand board, and fiberboard. Such materials may be made entirely of wood, such as pine, oak, maple, mahogany, cherry, and the like. In some cases, however, the materials may comprise wood in combination with another material, such as a resinous material, i.e., wood/resin composites, such as phenolic composites, composites of wood fibers and thermoplastic polymers, and wood composites reinforced with cement, fibers, or plastic cladding.

According to one particular aspect, at least one of the substrates is a metal. In another aspect, the substrates may be the same or dissimilar.

The syntactic structural adhesive may be applied as liquid, paste, and semi-solid or solid that can be liquefied upon heating. In some particular aspects, the syntactic structural adhesive is in a liquid or paste form. The syntactic structural adhesive may be applied onto the surface of the substrate as a continuous bead, in intermediate dots, stripes, diagonals or any other geometrical form.

The syntactic structural adhesive may be applied by any known technique such as by dipping, brushing, spray coating, die coating, roll coating, extruding, injection and contacting the substrate with a bath containing the syntactic structural adhesive manually and/or via automatic machine mixing and dispensing.

Before the applying treatment or coating of the syntactic structural adhesive upon the surface of the substrate(s), it is common practice, though not necessary, to remove foreign matter from the surface of the substrate(s) by thoroughly cleaning and degreasing the surface. Such cleaning typically takes place after forming the substrate into an end-use shape. The surface of the substrate can be cleaned by physical or chemical means, such as mechanically abrading the surface or cleaning/degreasing with commercially available alkaline or acidic cleaning agents which are well known to those skilled in the art, such as sodium metasilicate and sodium hydroxide.

Following the cleaning step, the substrate may be rinsed with deionized water or an aqueous solution of rinsing agents in order to remove any residue. The substrate can be air dried, for example, by using an air knife, by flashing off the water by brief exposure of the substrate to a high temperature or by passing the substrate between squeegee rolls.

The surface of the substrate to which the adhesive of the present disclosure is applied may be a bare, cleaned surface; it may be oily, pretreated with one or more pretreatment compositions, and/or prepainted with one or more coating compositions, primers, etc., applied by any method including, but not limited to, electrodeposition, spraying, dip coating, roll coating, curtain coating, and the like.

Although in some aspects not necessary, the syntactic structural adhesive placement options may be augmented by welding or mechanical fastening. Welding can occur as spot welds, as continuous seam welds, or any other weld that can cooperate with the syntactic structural adhesive to form a mechanically sound joint.

According to one aspect, the syntactic structural adhesive may be used as a structural adhesive in vehicle assembly, such as in the assembly of watercraft vehicles, aircraft vehicles, railway vehicles or motorcraft vehicles, for example, cars and motorbikes, or bicycles. In other aspects, the syntactic structural adhesive may be used as a structural adhesive in architecture or household and industrial applications.

In still other aspects, the syntactic structural adhesive may be used as a welding additive.

The present disclosure also provides a method of making a composite article comprising applying the syntactic structural adhesive of the present disclosure to a surface of a substrate and curing the adhesive to form a composite article.

In yet another aspect, there is provided a method of forming a bonded joint between at least two or more substrates comprising applying the syntactic structural adhesive of the present disclosure to a surface of at least one of the two or more substrates, joining the two or more substrates so that the syntactic structural adhesive is sandwiched between at least two of the two or more substrates and curing the syntactic structural adhesive to form a bonded joint between the two or more substrates.

The syntactic structural adhesives of the present disclosure may have, when cured, at least the following properties: a density of less than 1 g/cm³, a compression modulus of at least 500 MPa and a lap shear strength of greater than 750 psi, as measured according to the Examples section below.

In some aspects, the density of the syntactic structural adhesive, when cured, may be less than 0.95 g/cm³, or less than 0.9 g/cm³, or less than 0.85g/cm³, or less than 0.8 g/cm³, or less than 0.75 g/cm³, or even less than 0.7 g/cm³. In still other aspects, the density of the syntactic structural adhesive, when cured, may range from at least 0.4 g/cm³ to less than 1 g/cm³, such as from about 0.50 g/cm³ to about 0.95 g/cm³, or from about 0.6 g/cm³ to about 0.85 g/cm³ or from about 0.65 g/cm³ to about 0.75 g/cm³.

According to some aspects, the compression modulus of the syntactic structural adhesive, when cured, may be greater than 750 MPa, or greater than 1000 MPa, or greater than 1500 MPa, or greater than 2000 MPa, or even greater than 2250 MPa.

In yet other aspects, the lap shear strength of the syntactic structural adhesive, when cured, may be greater than 800 psi, or greater than 1000 psi, or greater than 1250 psi, or greater than 1500 psi, or greater than 1750 psi or even greater than 2000 psi.

### EXAMPLES

### Test Methods

### Lap Shear Strength—ASTM D1002

Lap shear strength was measured using ASTM D1002, which is incorporated herein by reference in its entirety. Two metal plates were bonded together with sample and cured as specified. The assembly was then cut into uniform width lap shear specimens. The test specimens were then placed in the grips of a universal testing machine and pulled at 1.3 mm/min (0.05 in/min) until rupture occurred.

### Compressive Strength and Compression Modulus—ASTM D695

Compressive strength and compression modulus were measured using ASTM D695, which is incorporated herein by reference in its entirety. The sample was placed between compressive plates parallel to the surface. The sample was then compressed at a uniform rate. The maximum load was recorded along with stress-strain data. An extensometer attached to the front of the fixture was used to determine compression modulus.

### Density—ASTM D792 and ASTM D1622

Density was measured using ASTM D792 and ASTM D1622, which are incorporated herein by reference in their entirety. The sample was weighed in air then weighed when immersed in distilled water at 23° C. using a sinker and wire to hold the sample completely submerged as required. A sample was also weighed then dimensioned with calipers. Density was calculated from these values.

### Gel Time and Work Life

(a) For two-component systems, the work life or gel time was determined as follows:

50.0 grams or 100.0 grams of the epoxy resin component was combined with the appropriate amount of hardener component. The mixture was then blended for 2 to 3 minutes, and allowed to stand at (77°±2°) F. The gel time or work life was reported as the amount of time that elapsed from the start of blending to the initial formation of a nonfluid mass.

(b) For one-component systems, the work life is determined as follows:

The sample was placed in a 6 oz. (150 mL) cartridge (Semco No. 250-C6 or equivalent). The cartridge did not have a nozzle. 75 psig to 85 psig air pressure was used to extrude 2 to 3 inches of sample to clear trapped air. The extruded material was then placed onto a tared sheet of paper for about 10 seconds with the sealant gun operating at full rate. While time could be adjusted depending upon how quickly the tube emptied, it was measured to the nearest second. The extruded compound was then weighed and the extrudability was calculated as follows:

Extrudability (g/min)=[weight extruded (g)×60 (sec/min)]/flow time (sec)

### Smoke Density and Vertical Burn Test—FAA Title 14 CFR/JAR/CS Part 25, Appendix F

Smoke Density and vertical burn were measured using FAA Title 14 CFR/JAR/CS Part 25, Appendix F, which is incorporated herein by reference in its entirety. The sample was placed vertically into a chamber and exposed to either radiant heat (non-flaming mode) or a flame (flaming mode) and the smoke density was measured in terms of optical density by analyzing the reduction of light transmission as the smoke accumulated.

The sample was aligned vertically and exposed to a small Bunsen burner flame at its lower edge. The flame was applied for 12 seconds or 60 seconds and then pulled away from the sample. If the sample continued to flame, this flame time was recorded, along with any flaming drips that may have occurred. After the test was over, the burn length was measured.

### Examples 1 to 4

The syntactic structural adhesives of Examples 1 to 4 were prepared by combining in each case the materials listed in Tables 1 and 2 in a half gallon container equipped with a high shear mixer with a 2.5 inch Cowles blade, followed by mixing with a planetary mixer. In Table 1, the amounts are given in weight percent, based on the total weight of the syntactic structural adhesive, while in Table 2, the amounts are given in weight percent, based on the total weight of either Part A or Part B.

All the ingredients, except the low density particulate filler, were mixed with the high shear mixer at a speed up to 2000 rpm for about 2 hours. The mixture was then transferred to a planetary mixture and mixed with the low density particulate filler for about 2 hours, followed by mixing under vacuum for about 10-15 minutes.

The syntactic structural adhesive of Example 1 was cured at 177° C. for one hour before subjecting the cured specimen to the relevant test. The syntactic structural adhesives of Examples 2, 3 and 4 were cured at room temperature for 3-5 days before subjecting the cured specimens to the relevant tests.

TABLE 1
One-Component Syntactic Structural Adhesive

| | Example 1 |
|---|---|
| Material | (wt. %) |
| Epoxy | 20-25 |
| Low Density Particulate Filler | 40-50 |
| Hardener | 30-35 |
| Flame Retardant | 5-15 |
| Additives | 0.5-5 |

TABLE 2
Two-Component Syntactic Structural Adhesive

| | Example 2 | Example 3 | Example 4 |
|---|---|---|---|
| Material | (wt. %) | (wt. %) | (wt. %) |
| Part A | | | |
| Epoxy | 60-70 | 50-55 | 50-55 |
| Low Density | 15-25 | 15-20 | 35-40 |
| Particulate Filler | | | |
| Multi-functional | 5-10 | 10-15 | 2-5 |
| Acrylate | | | |
| Flame Retardant | 15-20 | 15-20 | 0 |
| Additives | 5-10 | 1-5 | 10-15 |
| Part B | | | |
| Hardener | 70-80 | 60-70 | 55-65 |
| Low Density | 2-10 | 15-20 | 35-40 |
| Particulate Filler | | | |
| Flame Retardant | 15-20 | 15-20 | 0 |
| Additives | 0 | 2-5 | 5-10 |

Processing characteristics, mechanical strength, and physical properties are summarized in Table 3 below. Flame, smoke, and toxicity performance are also included in Table 3.

### Comparative Examples 1-3

Three state of the art structural adhesive examples used in automotive applications are also provided for comparison purposes. These adhesives were purchased directly from the market and applied as instructed by the manufacturer. Betamate™ 1776LWR adhesive (“Comp. 1”) is a one component epoxy-based composition, while Betamate™ 73326/73327 (“Comp. 2”) and Betamate™ 73312/73312 (“Comp. 3”) adhesives are two-component epoxy-based compositions. Typical processing characteristics, mechanical strength, and physical properties reported by the manufacturer are summarized in Table 3.

TABLE 3

| | | | | | | | | | Comp. | | Comp. | | Comp. | |
|---|---|---|---|---|---|---|---|---|---|---|---|---|---|---|
| Property | Ex. 1 | | Ex. 2 | | Ex. 3 | | Ex. 4 | | 1 | | 2 | | 3 | |
| Mix Ratio | — | | 20:100 | | 2:1 | | 2:1 | | — | | 1:1 | | 2:1 | |
| A:B | | | | | | | | | | | | | | |
| Open Time | >8 | hrs | 18 | min | 8 | min | 45 | min | — | | 120 | min | 30 | min |
| at 25° C. | | | | | | | | | | | | | | |
| Handling Time | 30 min at | | 5 hrs at | | 3 hrs at | | 6 hrs at | | 30 min at | | 6 hrs at | | 4 hrs at | |
| | 170° C. | | 25° C. | | 25° C. | | 25° C. | | 170° C. | | 25° C. | | 25° C. | |
| Compression | 2159 | MPa | 2750 | MPa | 2350 | MPa | 765 | MPa | 385 | MPa | 1100 | MPa | 4000 | MPa |
| Modulus | | | | | | | | | | | | | | |
| Lap Shear | 2150 | psi | 2100 | psi | 1985 | psi | 1290 | psi | 1500 | psi | 1600 | psi | 1800 | psi |
| Strength | | | | | | | | | | | | | | |
| Density | 0.7 | g/cm³ | 0.7 | g/cm³ | 0.7 | g/cm³ | 0.5 | g/cm³ | 1.25 | g/cm³ | 1.31 | g/cm³ | 1.25 | g/cm³ |
| Compression | 3084 | MPa | 3929 | MPa | 3357 | MPa | 1530 | MPa | 308 | MPa | 840 | MPa | 3200 | MPa |
| Modulus/Density | | | | | | | | | | | | | | |
| Lap Shear | 3071 | psi | 3000 | psi | 2836 | psi | 2580 | psi | 1200 | psi | 1221 | psi | 1440 | psi |
| Strength/Density | | | | | | | | | | | | | | |

| | | | | | | | |
|---|---|---|---|---|---|---|---|
| Flame, Smoke | Flame | Meets | Meets | Meets | Not | Not | Not |
| and Toxicity | Retardant | FST | FST | FST | Rated | Rated | Rated |
| | | standard | standard | standard | | | |

It is evident from Table 3 that the Inventive Examples 1-4 exhibited processing characteristics, such as cure conditions and handling time, similar to those for the state of the art adhesives. Inventive Examples 1-3 exhibited improved lap shear strength at significantly lower density. When the density is normalized, Inventive Examples 1-4 show improved lap shear strength over Comparative Examples 1-3. This was not expected since a reduction in density typically generates a corresponding reduction in mechanical properties. In addition, the inventive examples also demonstrated improved flame resistance, and Inventive Examples 2-4 meet U.S. Federal flame-smoke-toxicity requirements. The syntactic structural adhesives of the present disclosure therefore provide an efficient way to manage weight in automotive assemblies thus improving fuel efficiency which may further lead to an increase in travel range for electrical vehicles, without a loss in mechanical properties.

Although making and using various embodiments of the present invention have been described in detail above, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

What is claimed is:

1. A syntactic structural adhesive comprising:
(a) an epoxy resin;
(b) a low density particulate filler; and
(c) a hardener
wherein the syntactic structural adhesive, upon curing, exhibits at least the following properties: (i) a density less than 1 g/cm³; (ii) a compression modulus greater than 500 MPa; and (iii) a lap shear strength greater than 750 psi.

2. The syntactic structural adhesive according to claim 1 wherein the epoxy resin comprises at least one multi-functional epoxy resin.

3. The syntactic structural adhesive according to claim 2 wherein the multi-functional epoxy resin is a trifunctional epoxy resin.

4. The syntactic structural adhesive according to claim 1 wherein the hardener comprises a multifunctional amine or an acid anhydride.

5. The syntactic structural adhesive according to claim 1 wherein the low density particulate filler comprises inorganic microspheres.

6. The syntactic structural adhesive according to claim 1 which further comprises a multi-functional acrylate.

7. The syntactic structural adhesive according to claim 1 which further comprises a flame retardant consisting of a mixture of a compound selected from an alkaline earth metal hydroxide or an aluminum group hydroxide, and at least one phosphorous-containing material.

8. A method of forming a bonded joint between two substrates comprising providing the syntactic structural adhesive according to claim 1, applying the syntactic structural adhesive onto a surface of at least one of the two substrates, joining the two substrates so that the syntactic structural adhesive is sandwiched between the two substrates, and curing the syntactic structural adhesive to form a bonded joint between the two substrates.

9. The method according to claim 8 wherein at least one of the two substrates is a metal.

10. The method according to claim 9 wherein the other substrate is a metal.

11. The method according to claim 9 wherein the other substrate is not a metal.

12. The method of claim 8 wherein the two substrates are not a metal.

13. A one-component syntactic structural adhesive comprising from about 10 wt. % to about 70 wt. % of an epoxy resin, from about 2 wt. % to about 50 wt. % of a low density particulate filler and up to about 45 wt. % of a hardener, where the wt. % is based on the total weight of the syntactic structural adhesive, and wherein the one-component syntactic structural adhesive, upon curing, exhibits at least the following properties: (i) a density less than 1 g/cm³; (ii) a compression modulus greater than 500 MPa; and (iii) a lap shear strength greater than 750 psi.

14. The one-component syntactic structural adhesive according to claim 13 which further comprises up to about 40 wt. % of a flame retardant, where the wt. % is based on the total weight of syntactic structural adhesive.

15. A two-component syntactic structural adhesive comprising:
(a) a Part A comprising from about 10 wt. % to about 90 wt. % of an epoxy resin, from about 5 wt. % to about 80 wt. % of a low density particulate filler and from about 5 wt. % to about 60 wt. % of a flame retardant, where the wt. % is based on the total weight of Part A; and
(b) a Part B comprising from about 10 wt. % to about 90 wt. % of a hardener, from about 5 wt. % to about 80 wt. % of a low density particulate filler and from about 5 wt. % to about 60 wt. % of a flame retardant, where the wt. % is based on the total weight of Part B;
wherein upon mixing Part A and Part B together to form a syntactic structural adhesive and curing the syntactic structural adhesive provides a cured material that exhibits at least the following properties: (i) a density less than 1 g/cm³; (ii) a compression modulus greater than 500 MPa; and (iii) a lap shear strength greater than 750 psi.

16. The two-component syntactic structural adhesive according to claim 15 wherein Part A further comprises from about 0.5 wt. % to about 25 wt. % of a multifunctional acrylate, where the wt. % is based on the total weight of Part A.

17. The two-component syntactic structural adhesive according to claim 15 wherein Part A and Part B are mixed at a weight ratio of about 0.2:1 to about 2:1.
